(19) United States
(12) Patent Application Publication
(10) Pub. No.: US 2014/0244224 A1
(43) Pub. Date: Aug. 28, 2014

(54) RAPID ASSESSMENT OF SUSPENSION GEOMETRY FOR LOADS

(71) Applicant: FORD GLOBAL TECHNOLOGIES, LLC, Dearborn, MI (US)

(72) Inventors: Liang Tang, Ann Arbor, MI (US); Anil Kumar Dhir, Ann Arbor, MI (US); John Joseph Uicker, Dearborn, MI (US)

(73) Assignee: Ford Global Technologies, LLC, Dearborn, MI (US)

(21) Appl. No.: 13/779,979

(22) Filed: Feb. 28, 2013

(51) Int. Cl. G06F 17/50

(52) U.S. Cl. CPC G06F 17/5009
USPC 703/2

(57) ABSTRACT

A model of a vehicle suspension includes an indication of a suspension type. A plurality of suspension hard points for modeling output loads are selected. An input point in the suspension is defined, including input loads at the input point. A set of equations is created using the input loads and the selected hard points, each equation representing a load in one of an X, Y, and Z direction in a three-dimensional coordinate system. At least one constraint equation is added to the set of equations. The equations are solved to determine output loads for each of the selected hard points.

### BACKGROUND

A vehicle suspension's cost and durability are greatly influenced by its geometry. In the design of a suspension the selection of suspension hard points generally determines how spindle input loads will be distributed internally. A poor selection of hard points may result in amplification of input loads, causing high loads to be applied to internal structures of the suspension. A poor selection of hard points may also cause higher loads at attachments where higher loads are undesirable, e.g., leading to higher materials and manufacturing costs, higher weights, etc.

In the early stages of vehicle suspension design and development, decisions are generally made regarding suspension architecture within the constraints of a given packaging space. These design decisions require quick assessments concerning key attributes of the suspension, including durability. Load data for durability design assessments are traditionally derived from a multi-body dynamic modeling/simulation of an entire suspension system subjected to spindle input loads such as may be performed by commercially available multi-body dynamic (MBD) software, examples of which include the ADAMS software package provided by MSC Software Corporation of Santa Ana, Calif., and Virtual Lab Motion software package provided by LMS International (a subsidiary of Siemens AG) of Leuven, Belgium. However, this traditional approach is unable to provide quick design assessments.

Shortcomings of existing systems include their reliance on voluminous and detailed design data to model a suspension system. The complete data needed is generally unavailable and/or not well-defined in their entirety in the early stages of development. Further, traditional systems, because they use detailed data, and generally carry out traditional steps of pre-processing, simulation runs, and post-processing. Further, in early stages of design it is generally difficult, if not impossible, to perform Design of Experiments (DOE)/Optimization studies needed for durability-friendly design recommendations.

### BRIEF DESCRIPTION OF THE DRAWINGS

FIG. 1 is a block diagram of an exemplary suspension load evaluation system.

FIG. 2 is a side view of an exemplary model suspension.

FIG. 3 illustrates a screenshot included in a graphical user interface provided by an exemplary implementation of the evaluation module.

FIG. 4 illustrates an exemplary process for determining suspension loads, i.e., output forces.

FIG. 5 is a diagram of an exemplary process for determining output forces.

FIG. 6 is a diagram of an exemplary process for using information about suspension hard points in a design of experiments (DOE) exercise.

### DETAILED DESCRIPTION OF PREFERRED EMBODIMENTS

### Introduction

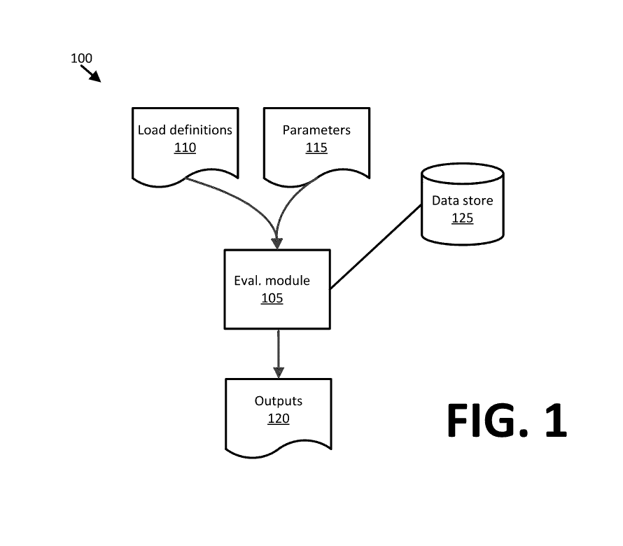

FIG. 1 is a block diagram of an exemplary suspension load evaluation system 100. An evaluation module 105 receives inputs 110 that include a definition of an input point and input loads, e.g., forces at the input point and moments. The evaluation module 105 may also receive parameters 115 that may be used to govern aspects of providing outputs 120. The outputs 120 identify predicted loads at various suspension hard points. The evaluation module 105 may use information from a data store 125 and/or may store outputs 120 in the data store 125.

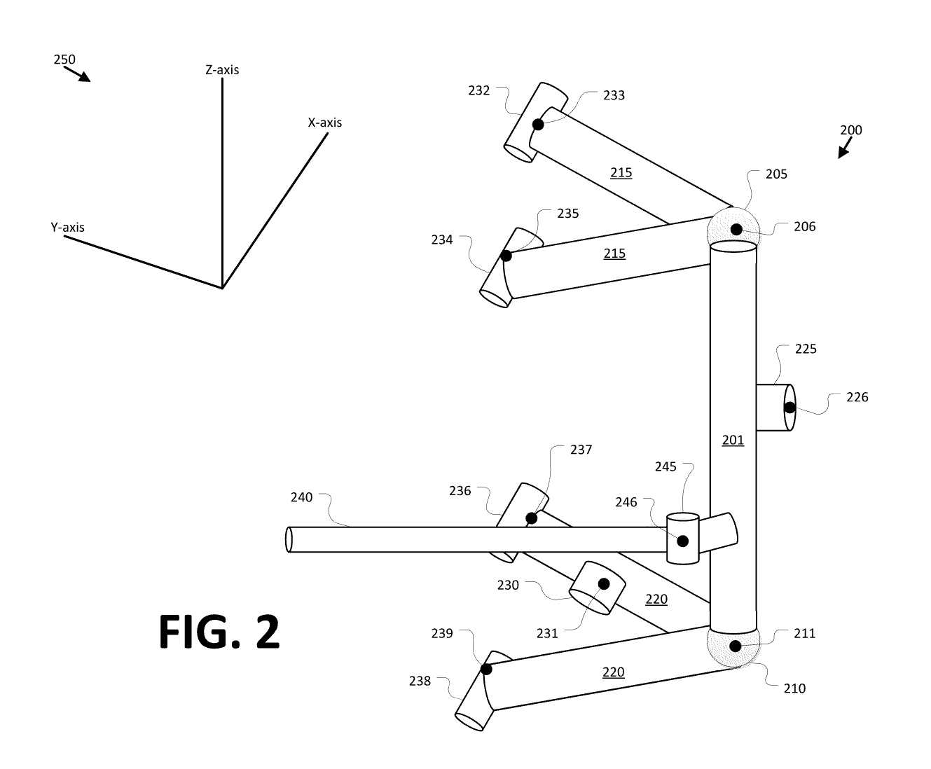

Operation of the suspension load evaluation system 100 may be understood with respect to an exemplary model of a vehicle suspension. Accordingly, FIG. 2 is a side view of an exemplary short long arms (SLA), or double wishbone, model suspension 200. The model suspension 200 includes conventional parts, including a spindle 201 disposed vertically and having ball joints 205 and 210 at respective top and bottom ends. Upper control arms 215, and lower control arms 220, are connected to the spindle 201 at the ball joints 205 and 210, respectively. A wheel attachment 225, including a point indicating a wheel center 226, is attached to the spindle 201 for attaching a vehicle wheel (not shown). It should be understood that the wheel center 226 could represent a point at various locations on a tire/wheel assemble, such as a wheel center, a tire contact patch, etc. In any case, the wheel center 226 may serve as a hard point for modeling loads in the model suspension 200. A shock attachment 230 is attached to one of the control arms 220 for attaching a shock absorber (not shown) to the suspension 200. A hard point 231 may be associated with the shock attachment 230 to facilitate modeling of loads associated with the shock attachment 230. The control arms 215, 220 are attached to frame attachments 232, 234, 236, and 238 for attaching the suspension 200 to a vehicle frame (not shown). Respective hard points 233, 235, 237, and 239 may be respectively associated with the frame attachments 232, 234, 236, and 238 as shown in FIG. 2, thereby facilitating modeling of loads at points 233, 235, 237, and 239 where control arms 215 and 220 are connected to the frame attachments 232, 234, 236, and 238, e.g., as shown in FIG. 2. A tie rod 240 is connected to the spindle 201 via a connector 245.

Evaluating the model suspension 200 generally includes evaluating loads on the suspension at various points. For example a wheel center 226 may be a load point on the wheel attachment 225. Ball joint centers 206 and 211 may be used to represent suspension hard points that are load points at a top and bottom of the spindle 201, respectively. Further, tie rod end point 246 may be used to indicate a load at an end point of a tie rod 240. As disclosed herein, given a set of input loads for a first point in a model suspension 200, it is possible to determine output loads for other points in the model suspension 200.

FIG. 2 also includes an exemplary three-dimensional coordinate system, e.g., an XYZ-coordinate system 250. Loads, e.g., forces and moments, on various hard points of the suspension 200 may be known, or may be calculated, with respect to a coordinate system such as the XYZ-coordinate system 250, as explained herein.

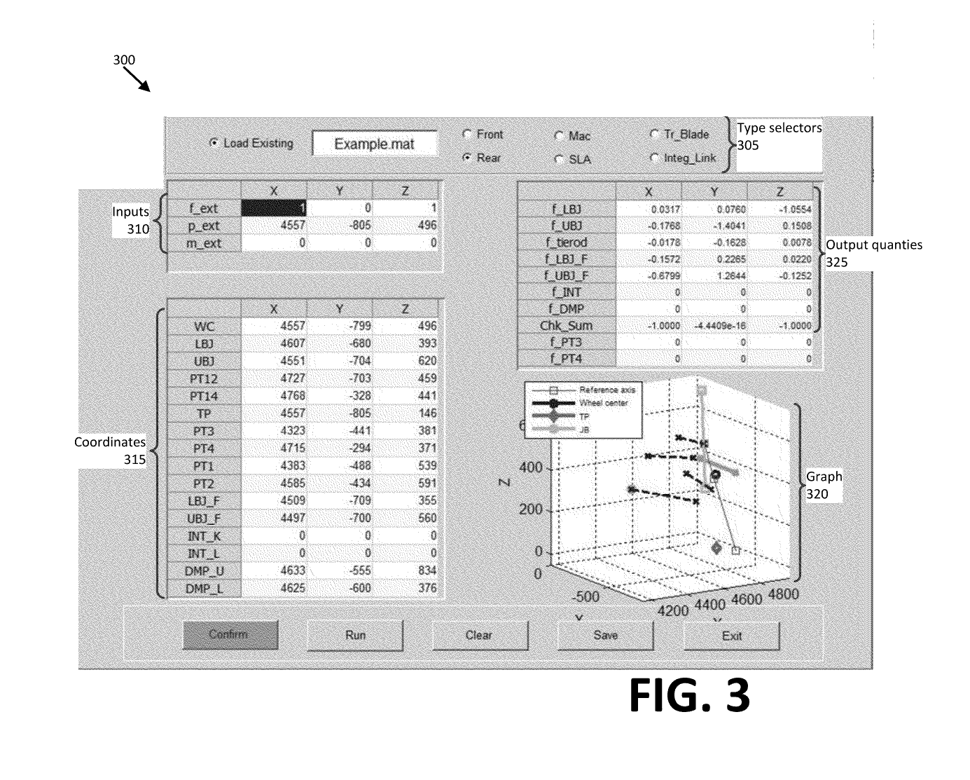

FIG. 3 illustrates a screenshot included in a graphical user interface 300 provided by an exemplary implementation of the evaluation module 105.

The interface 300 includes type selectors 305. The type selectors 305 allow a user to provide input to the module 105 indicating a type of vehicle suspension 200 to be evaluated, as well as a location, e.g., front or rear, of the model suspension 200.

Inputs 310 include known loads on a hard point in a model vehicle suspension 200, e.g., the wheel center 226, in each of the X, Y, and Z directions. The input 310 loads, e.g., forces indicated by the label “f_ext,” may be provided by direct user input, e.g., a user entering values in a field or fields in the interface 300, or may be loaded from a file, from a table in the data store 125, etc. Coordinates for an input point are indicated by the label “p_ext.” Further, although not shown in FIG. 3, other input loads, e.g., moments, could be provided in other lines of the field for providing inputs 310.

Coordinates 315 indicate coordinates of various respective suspension 200 hard points in an XYZ-coordinate system such as the system 250. The table of coordinates 315 may be linked to a visual graph 320 that displays the various suspension 200 hard points so as to allow visualization and movement and rearrangement of the hard points. Thus, the display of hard points in the graph 320 may be determined according to values entered or loaded into the table of coordinates 315. Further, values in the coordinates 315 may be changed by changing the display in the graph 320. For example, a user could, e.g., using click-and-drag operations or the like such as are known in various software tools for graphically representing and manipulating visual data, move a line or point in the graph 320 representing a point and/or component in a suspension model 200.

Output loads 325 are determined according to loads 310 and coordinates 315 for a model suspension 200, a type of which is specified according to the selectors 305. Further, a “check sum” record is generated to compare the sums of the various determined output loads 325 to the provided input loads 310, thus confirming accuracy of the system 100.

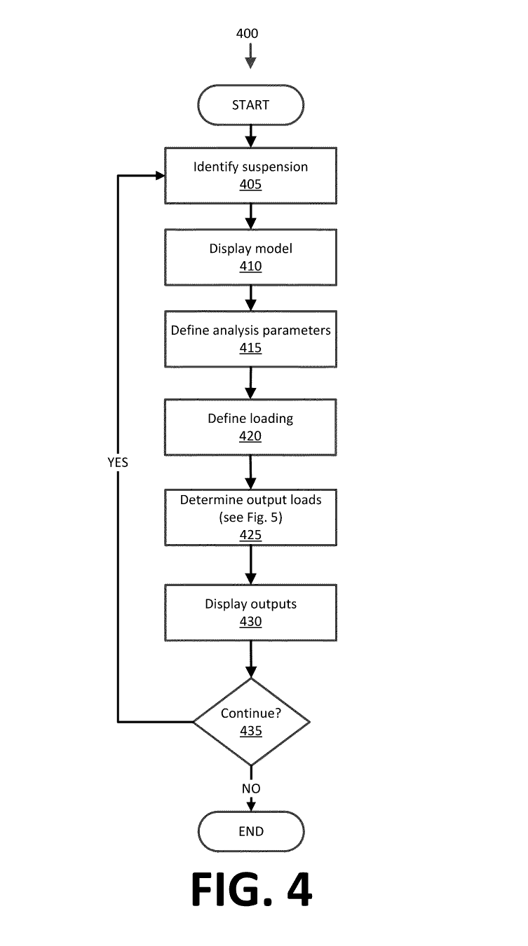

FIG. 4 illustrates an exemplary process 400 for determining suspension 200 loads, i.e., output loads 325. The process 400 is generally carried out according to instructions stored on a computer-readable medium, e.g., a memory or storage device of a general-purpose computer. For example, such instructions may be included in the evaluation module 105, possibly working in conjunction with software tools such as MATLAB® by the MathWorks Inc., of Natick, Mass.

The process 400 begins in a block 405, in which a suspension 200 being modeled is identified. Identifying a suspension 200 generally includes identifying a type of suspension 200, as well as identifying hard points in the suspension, e.g., specifying coordinates 315. As noted above, a model suspension 200 type is generally indicated according to type selectors 305 or the like in an evaluation module interface 300. The evaluation module 105 may include different sets of instructions for different model suspension 200 types. Further one of these sets of instructions, i.e., a set of instructions for a selected suspension 200 type, may be selected for execution in block 405. Coordinates 315 could be loaded from a file input by hand, retrieved from a remote data store, etc.

Next, in a block 410, the graph 320 is displayed. For example, for selected suspension 200 type, a default set of hard points and respective coordinates 315 for the hard points may be selected, according to which, the graph 320 may be displayed.

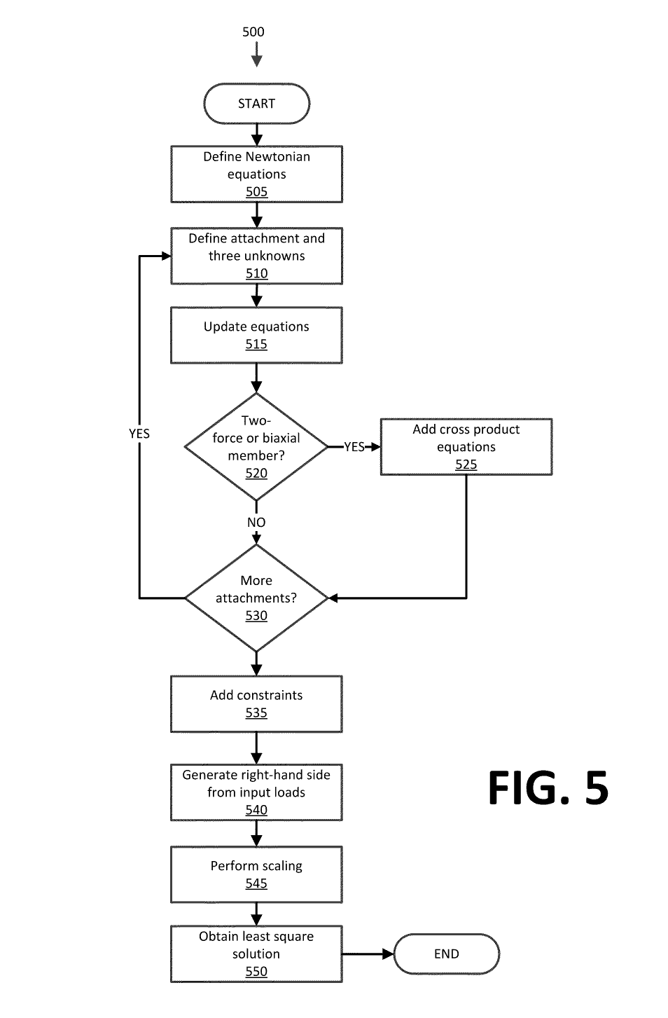

Next, in a block 415, analysis parameters may be defined. For example, it may be useful to scale solution equations (such as are discussed regarding blocks 505, 515 mentioned below in connection with FIG. 5) and input values (e.g., as discussed below regarding block 540 of FIG. 5) to obtain more accurate results. Application of scale factors on translational force equations and constraint equations generally improves the rank of a solution matrix and allows for errors derived from the least square solution to distribute more uniformly. Generally a scale factor with a magnitude on the order of nominal dimensions of a suspension system provides the best results. Accordingly, the interface 300 could include a form or other mechanism for providing analysis parameters.

Next, in a block 420, input loads 310 are defined. For example, the input loads 310 could be provided according to user entry in a form in the interface 300, loaded from a file, etc. In one exemplary implementation of the system 100, the input loads 310 include forces and/or moments.

Next, in a block 425, output loads 325 are determined. Details of an exemplary process for determining output loads 325 are discussed below with respect to FIG. 5.

Next, in a block 430, the outputs 325 are displayed in the interface 300.

Next, in a block 435, the module 105 determines whether input has been received to continue or and the process 400. If input to continue has been received, e.g., input loads 310 have been changed, a suspension 200 type has been changed, etc. then the process 400 returns to block 405. Otherwise, the process 400 ends.

FIG. 5 is a diagram of an exemplary process 500 for determining output forces 325. The process 500 is generally carried out according to instructions stored on a computer-readable medium, e.g., a memory or storage device of a general-purpose computer. For example, such instructions may be included in the evaluation module 105, generally working in conjunction with a tool such as MATLAB®.

The process 500 begins in a block 505, in which a set of Newtonian equations are defined to describe balancing of input loads 310 with output quantities 325. As an example, assume that input loads 310, e.g., forces, Fᵢₓ, F_{iy}, and F_{iz} at a wheel center 226 are known. Output loads 325 at various hard points in the model suspension 200 are unknown, and to be determined.

For example, equations could be defined to show the balancing of force quantities 325 and moment quantities 325 in each of the X, Y, and Z directions of a coordinate system 250. That is, assuming that a sum of forces in the X direction must be zero, a Newtonian equation would state that, for output forces 325 on suspension 200 components a b, and c, and an input force 310 in the X direction on the suspension 200:

ΣFₓ=0:Fₐₓ+F_{bx}+F_{cx}+Fᵢₓ=0.

Similar equations may be written for forces in the Y and Z directions, as well as for moments in the X, Y, and Z directions. The Newtonian equations resulting from block 505 may be represented in various ways, e.g., in a matrix. These equations, as augmented and modified as described herein, are sometimes referred to herein as the “set of equations.” In an exemplary implementation the set of equations includes six equations, one each to summarize forces in each of the X, Y, and Z directions, and one each to summarize moments in each of the X, Y, and Z directions.

Following block 505, in a block 510, the evaluation module 105 defines an attachment in the model suspension 200, e.g., one of the elements shown in FIG. 2. Three unknown values are defined for the attachment, e.g., forces in each of the X, Y, and Z directions.

Next, in a block 515, the equations defined in block 505 are updated to account for the attachment and its unknown values specified in block 510. For example, where the equations are represented in a matrix, three columns may be added to the matrix representing the unknown values.

Next, in a block 520, it is determined whether the attachment specified in block 510 is for a two-force or biaxial member, such as are known, in the suspension 200. If yes, the process 500 proceeds to a block 525. Otherwise, the process 500 proceeds to a block 530.

In the block 525, which is executed because a specified attachment is from a two-force or biaxial member in the suspension 200, additional equations, sometimes referred to as constraint equations, are added to the Newtonian equations that were defined in the block 505, and augmented in the block 515. For example, in the case of a uniaxial two-force member, three cross product equations may be added; in the case of a biaxial member, one cross product equation may be added. In the case of a two-force member, three constraint equations are derived from the member's axial direction and three forces of the member to impose the condition that the resultant force of the three forces is along the member axial direction. In the case of a bi-axial loaded member, one constraint equation is added to the set of equations to impose the condition that the resultant force of the three forces has zero value in the direction perpendicular to the member's axial direction and the resultants of the applied forces within the span of the member. Thus, where the set of equations is represented in a matrix, three or one rows may be added to the matrix in the block 525, i.e., a row is added to the matrix for each constraint equation that is added to the set of equations.

Following either block 520 or block 525, it is determined in a block 530 whether further attachments in the suspension 200 remained to be processed. If so, the process 500 returns to the block 510. Otherwise, a block 535 is executed next.

In the block 535, an appropriate constraint or constraints are added to the set of equations as warranted to improve the results. For example the vertical force of a member in the model suspension 200 may be constrained to zero to model the presence of the vertical travel in the suspension 200. The constraints may be, e.g., where the set of equations is expressed as a matrix, in the form of a vector by which the matrix is multiplied.

Next, in a block 540, the module 105 determines a solution for the set of equations, e.g., a right-hand side vector. For example, the right-hand side vector may include three major segments. The first segment is for translation force balancing, and represents the negative of input forces 310, e.g., f_ext shown in FIG. 3. The second segment is for moment balancing. First, a three component moment is derived from summing a moment induced from the translational forces about an arbitrarily chosen point and the applied moments in shown in input forces 310. The second segment includes negative values of the three moments. The third segment consists of an array of zero values.

Next, in a block 545, the set of equations may be scaled for improved accuracy. For example, analysis parameters may have been provided by a user as input via the graphical user interface 300 indicating scaling to be performed. For example, scaling may be desirable so that the equations in a set of equations are of similar magnitudes. Otherwise, obtaining a least square solution, as discussed in the next paragraph, may be difficult.

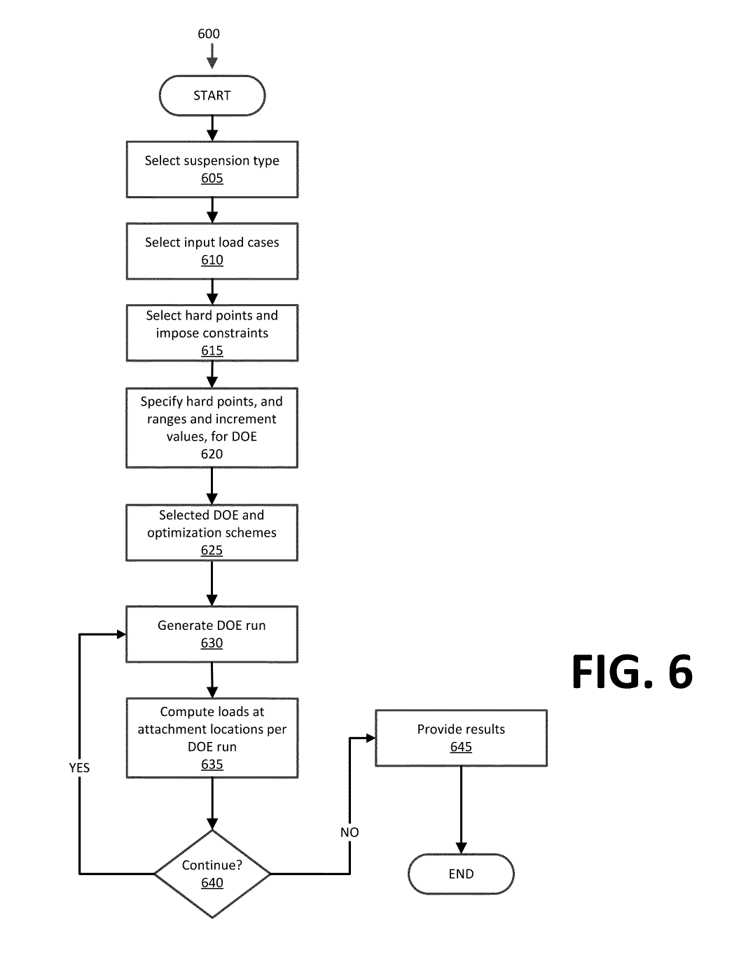

Next, in a block 550, the set of equations is processed to obtain output quantities 325, e.g., a set of forces associated with specified hard points in a model suspension 200. Generally, only one least square solution is executed per analysis; no iterative solutions are required. For example, a least square solution to the set of equations may be obtained. Such solution may provide values such as are displayed as output quantities 325 in the interface 300. Further, the solution may be used in a design of experiments run, as described in more detail below with respect to FIG. 6.

Following the block 550, the process 500 ends.

FIG. 6 is a diagram of an exemplary process 600 for using information about suspension 200 hard points in a design of experiments (DOE) exercise. The process 600 may thus utilize the evaluation module 105, along with a commercially available software tool or tools for conducting the design of experiments exercise. One non-limiting example of such a tool is modeFRONTIER, provided by ESTECO s.p.a of Trieste, Italy.

The process 600 begins in a block 605, in which a type of suspension 200 is selected to be the subject of the experiments.

Next, in a block 610, one or more input load cases are selected for the design of experiments exercise. For example, three input load cases may be selected, specifying various locations of a wheel center. The purpose of the design of experiments exercise is to evaluate the different input load cases in combination with various hard point configurations to assist in designing a vehicle suspension.

Next, in a block 615, hard points, and associated output loads 325, are selected, e.g., as described above.

Next, in a block 620, the hard points are specified for the design of experiments exercise, along with possible ranges and increment values. That is, a design of experiments generally evaluates a range of possible values for a system element, in this case, load values associated with specified hard points.

Next, in a block 625, methodologies for the design of experiments exercise and an optimization are selected. Various such methodologies are known. For example, in one implementation, the Sobol method is used to generate a design of experiments matrix. Further for example, a genetic optimization, e.g., a basic genetic method such as the one known as MOGA-II may be used.

Next, in a block 630, a DOE run is generated according to scheme selected as described with respect to block 625.

Next, in a block 635, loads at specified attachment locations are computed according to the DOE run.

Next, in a block 640, it is determined whether a maximum number of DOE runs has been reached. If so, the process 600 proceeds to a block 645. Otherwise, the process 600 returns to the block 630.

In block 645, DOE results are post-processed, if needed, and provided in one or more various formats, such as a table, a graph display, etc. DOE results can be used to identify input loads 310 that result in optimal outputs 325. DOE results can be used to identify and establish suspension geometry (i.e. hard points) that yields desirable (e.g., optimal) output 325 under input load 310.

Following the block 645, the process 600 ends.

### CONCLUSION

Computing devices such as disclosed and referred to herein may employ any of a number of computer operating systems, including, but by no means limited to, versions and/or varieties of the Microsoft Windows® operating system, the iOS by Apple Computer, Inc., Android by Google, Inc., the Unix operating system (e.g., the Solaris® operating system distributed by Sun Microsystems of Menlo Park, Calif.), the AIX UNIX operating system distributed by International Business Machines (IBM) of Armonk, N.Y., and the Linux operating system. Computing devices in general may include any one of a number of computing devices, including, without limitation, a computer workstation, a desktop, notebook, laptop, or handheld computer, or some other computing device.

Computing devices such as those discussed herein generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein, e.g., data store 145, etc., may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. Database 115 may be any of a variety of known RDBMS packages, including IBMS DB2, or the RDBMS provided by Oracle Corporation of Redwood Shores, Calif.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method, comprising:
creating a model of a vehicle suspension, including an indication of a suspension type;
selecting a plurality of suspension hard points for modeling output loads;
defining an input point in the suspension, including input loads at the input point;
creating a set of equations using the input loads and the selected hard points, each equation representing a load in one of an X, Y, and Z direction in a three-dimensional coordinate system;
adding at least one constraint equation to the set of equations;
solving the equations to determine output loads for each of the selected hard points.

2. The method of claim 1, wherein the suspension loads include at least one of forces and moments.

3. The method of claim 2, wherein the set of equations includes three force equations and three moment equations.

4. The method of claim 1, further comprising representing the set of equations in a matrix.

5. The method of claim 1, wherein the at least one constraint equation includes at least one of (a) three constraint equations derived from a two-force member's axial direction and three forces of the member to impose a condition that a resultant force of the three forces is along the member axial direction, and (b) one constraint equation impose a condition for a bi-axial loaded member that the resultant force of three forces has zero value in the direction perpendicular to the member's axial direction and the resultant of the applied forces within the span of the member.

6. The method of claim 1, further comprising using the output loads in a design of experiments exercise.

7. The method of claim 1, further comprising applying a constraint vector to the set of equations.

8. A non-transitory computer-readable medium including having embodied thereon computer-executable instructions, the instructions comprising instructions for:
creating a model of a vehicle suspension, including an indication of a suspension type;
selecting a plurality of suspension hard points for modeling output loads;
defining an input point in the suspension, including input loads at the input point;
creating a set of equations using the input loads and the selected hard points, each equation representing a load in one of an X, Y, and Z direction in a three-dimensional coordinate system;
adding at least one constraint equation to the set of equations;
solving the equations to determine output loads for each of the selected hard points.

9. The medium of claim 8, wherein the suspension loads include at least one of forces and moments.

10. The medium of claim 9, wherein the set of equations includes three force equations and three moment equations.

11. The medium of claim 8, the instructions further comprising instructions for representing the set of equations in a matrix.

12. The medium of claim 8, wherein the at least one constraint equation includes at least one of (a) three constraint equations derived from a two-force member's axial direction and three forces of the member to impose a condition that a resultant force of the three forces is along the member axial direction, and (b) one constraint equation impose a condition for a bi-axial loaded member that the resultant force of three forces has zero value in the direction perpendicular to the member's axial direction and the resultant of the applied forces within the span of the member.

13. The medium of claim 8, the instructions further comprising instructions for using the output loads in a design of experiments exercise.

14. The medium of claim 8, the instructions further comprising instructions for applying a constraint vector to the set of equations.

15. A system, comprising a computing device that includes a processor and a memory, the memory storing instructions executable by the processor, the instructions comprising instructions for:
creating a model of a vehicle suspension, including an indication of a suspension type;
selecting a plurality of suspension hard points for modeling output loads;
defining an input point in the suspension, including input loads at the input point;
creating a set of equations using the input loads and the selected hard points, each equation representing a load in one of an X, Y, and Z direction in a three-dimensional coordinate system;
adding at least one constraint equation to the set of equations;
solving the equations to determine output loads for each of the selected hard points.

16. The system of claim 15, wherein the suspension loads include at least one of forces and moments.

17. The system of claim 16, wherein the set of equations includes three force equations and three moment equations.

18. The system of claim 15, the instructions further comprising instructions for representing the set of equations in a matrix.

19. The system of claim 15, wherein the at least one constraint equation includes at least one of (a) three constraint equations derived from a two-force member's axial direction and three forces of the member to impose a condition that a resultant force of the three forces is along the member axial direction, and (b) one constraint equation impose a condition for a bi-axial loaded member that the resultant force of three forces has zero value in the direction perpendicular to the member's axial direction and the resultant of the applied forces within the span of the member.

20. The system of claim 15, the instructions further comprising instructions for using the output loads in a design of experiments exercise.

21. The system of claim 15, the instructions further comprising instructions for applying a constraint vector to the set of equations.
